(19) United States
(12) Patent Application Publication
(10) Pub. No.: US 2004/0259067 A1
(43) Pub. Date: Dec. 23, 2004

(54) Method and system for receiving responses utilizing digital pen and paper

(76) Inventors: Preston Cody, San Antonio, TX (US); Yigal Attali, Lawrenceville, NJ (US); William Neary, Newtown, PA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/847,268

(22) Filed: May 17, 2004

Related U.S. Application Data
(60) Provisional application No. 60/471,281, filed on May 16, 2003.

(51) Int. Cl. G06F 17/30; G09B 7/00

(52) U.S. Cl. 434/323

(57) ABSTRACT

A method for permitting a user of a recording device that produces information both on a physical document and within an electronic memory to change a selected response is disclosed. Additionally, the method permits the user to reselect a previously deselected response. Moreover, methods for managing identification information for multiple users using one or more recording devices and for administering an exam to multiple users using multiple recording devices are disclosed.

### CROSS-REFERENCE TO RELATED APPLICATIONS

This patent application claims priority to, and incorporates by reference in its entirety, U.S. Provisional Patent Application No. 60/471,281, entitled “Method and System for Assessment Utilizing Digital Pen and Paper” and filed May 16, 2003.

### TECHNICAL FIELD

The present invention comprises a method and system for utilizing a multi-functional writing device that unambiguously records a selection of one of multiple options (e.g., an answer to a multiple choice test question or a vote lodged on an election ballot) in both written and electronic formats. The method of the present invention allows options to be selected and deselected such that the intended final selection is unambiguous within the memory of the writing device and on the writing surface.

### BACKGROUND

People are often engaged in activities that require their intent to be recorded on an official document (e.g., election ballots, drug prescription pads, standardized tests, surveys, etc.). Such activities are often administered on a large scale, such as statewide elections or college entrance examinations, and have time and cost constraints that preclude manual processing of each document at the conclusion of the administration. Accordingly, information-processing devices are typically employed to extract each respondent's intent (i.e., the intended response to a question or other stimulus) from the documents.

Presently, two methods are commonly used to capture and extract respondents' intent from documents: punch cards and optically scanned pencil marks. Punch cards are typically used for ballots. A voter is directed to mark the card by punching out a hole next to each selected candidate. Florida's tabulation of the 2000 Presidential Election results exposed numerous problems with punch cards. One such problem is that a hole cannot be “unpunched” and, as a result, a voter cannot change his selection without spoiling his ballot.

Using optically scanned pencil marks is a second method of capturing and extracting a respondent's intent from a document. Lead (No. 2) pencils are heavy in carbon, which is easily detected using infrared scanners. Standardized testing includes answer sheets, which are usually rendered as “bubble sheets.” Oval or square spaces are laid out on a testing sheet to permit an examinee to use a pencil to fill in the spaces corresponding to his answer choices. This method is preferable to punch cards, as pencil marks are erasable, which allows an examinee to change his selections without spoiling his answer sheet.

However, one problem with each of punch cards and optically scanned pencil marks is the cost associated with converting the physical information recorded on the surfaces into digital information that can be processed, tabulated, or scored. Many election boards and assessment organizations are attempting to reduce such costs by phasing out the traditional paper-based methods and phasing in computerized solutions. However, official requirements or up-front cost constraints often preclude the elimination of the physical document. Thus, in many cases, it is neither possible nor practical to set up computerized stations to record a respondent's intent directly into an information-processing device.

Devices exist for simultaneously recording human intent against a surface both physically and electronically. For example, U.S. Pat. No. 6,502,756 describes use of a writing device which simultaneously marks a surface and digitally records the strokes. Although this device is useful in recording the intent of a user on both a physical record and digitally, use of this device in recording responses to questions is not obviously practical primarily because such devices do not permit the user to change his or her answer one or more times and have the final selection unambiguously recorded on both the writing surface and digitally.

A third method of capturing and extracting respondents' intent from documents is time-based identification. Time-based identification permits a recording device to record a timestamp indicating when an operation within a given answer area occurred. When the information is downloaded to an information-processing device, the latest timestamp recorded for an area associated with a given question or elected office may be used to determine which selection was chosen last.

One problem with time-based identification is that a physical recordation of the capture of information is not retained. A paper copy does not indicate which selection occurred first. In other words, it would not be clear to a user during the information-capture process, or to an auditor after the fact, which of several answers the user intended. This is similar to the overvote problem that plagued the Florida tabulation of the 2000 Presidential Election results in that multiple answers can appear to be selected in the physical copy.

Accordingly, what is needed is a method and system for utilizing a writing device that permits the user to change their selection to one of a plurality of responses yet unambiguously records the selection in both the physical and digital formats.

### SUMMARY

Before the present methods and systems are described, it is to be understood that this invention is not limited to the particular methodologies and systems described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a,” “an,” and “the” include plural references unless the context clearly dictates otherwise. Thus, for example, reference to a “recording device” is a reference to one or more recording devices and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the present invention, the preferred methods, materials, and devices are now described. All publications mentioned herein are incorporated by reference. Nothing herein is to be construed as an admission that the invention is not entitled to antedate such disclosure by virtue of prior invention.

The present invention provides a method for utilizing dual mode writing instruments to enable a user to select one of a plurality of options in response to an inquiry or other prompt. The present invention utilizes a dual mode writing instrument, such as that described in U.S. Pat. No. 6,502,756, to record responses to a question or other stimulus in both a physical (i.e. markings on a physical surface) and electronic format. Importantly, the methodology of the present invention may permit the user to select and deselect responses and ultimately designate a final answer that appears unambiguously in both the physical and electronic format utilizing well-recognized symbology. As a result, the present invention finds application in standardized and other examinations utilizing multiple-choice questions, ballots and other settings in which a user selects at least one of a plurality of options.

The present invention further provides a technique that allows users of dual mode recording devices to select and then change their selections in response to a question, yet unambiguously records the final selection in both formats.

The system of the present invention comprises an assessment or ballot form that is formatted to optimize functionality with a dual mode writing device. For example, a ‘checkbox’ is placed next to each of the potential responses. A user may place a predetermined mark within a checkbox to record his or her response.

To select an option, the user places a predetermined mark, such as a checkmark, within the region of the answer area corresponding to the selected option. Deselection corresponds with a symbol used to register a negative human intent against a selection. In this context, deselection may be accomplished by placing an unambiguous mark through the checkmark to clearly negate the selection. The user may then select an alternate response, including a response previously deselected. This process may be repeated a plurality of times with the user selecting and deselecting responses until arriving at a final selection. The final selection is unambiguously recorded in both the physical format and the electronic format.

Various aspects and applications of the present invention will become apparent to the skilled artisan upon consideration of the brief description of the figures and the detailed description of the invention which follows.

### BRIEF DESCRIPTION OF THE DRAWINGS

Aspects, features, benefits and advantages of the embodiments of the present invention will be apparent with regard to the following description, appended claims and accompanying drawings where:

FIG. 1 is a flow diagram of an exemplary method of administering an exam to a user using a recording device according to an embodiment.

FIG. 2 is a flow diagram of an exemplary method of managing the identity of a user using a recording device according to an embodiment.

FIG. 3 is a depiction of a sample question in which the selection and deselection techniques are practiced according to an embodiment.

FIG. 4 is a depiction of an exemplary pattern region in which selection and deselection techniques are practiced according to an embodiment.

FIG. 5 is a depiction of an exemplary answer area in which selection, deselection and reselection techniques are practiced according to an embodiment.

FIG. 6 is a depiction of a sample question in which the selection and deselection techniques are shown according to an embodiment.

FIG. 7 is a depiction of a sample question in which the selection, deselection, and reselection techniques are shown according to an embodiment.

FIG. 8 is a diagram of the relevant features of exemplary symbology for selection and deselection according to an embodiment.

### TECHNICAL DESCRIPTION

The present invention provides methods and systems for permitting users of dual mode recording devices that record information both on a physical surface and within electronic memory to change a response one or more times and unambiguously indicate their final response physically and electronically. In addition, the present invention provides methods and systems for administering a standardized examination utilizing a writing instrument that records the pen strokes of the writer both physically (i.e. as marks on a surface) and electronically.

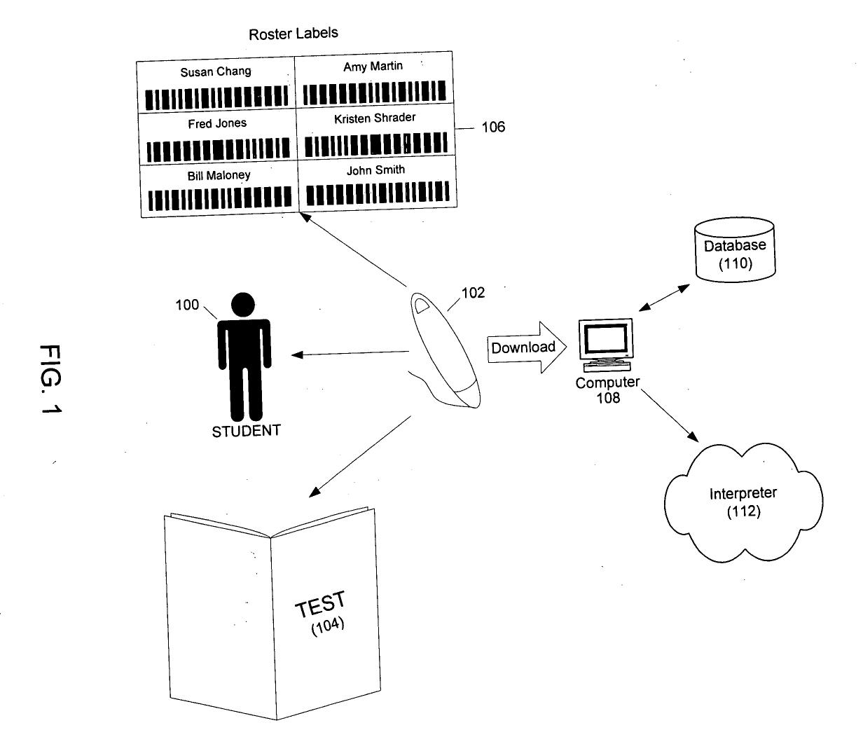

An exemplary method of administering an exam to a user using a dual mode recording device is illustrated in FIG. 1. One or more users 100 may simultaneously undergo the described method. According to the exemplary embodiment, a test administrator may provide a recording device 102 and a test booklet 104 to each user 100. The recording device 102 may be used to record relevant data in an electronic format and in a physical written format on the test booklet 104. A user identification label 106 may be affixed to the user's test booklet 104. The user identification label 106 may contain user identification information such as the name of the user 100 in both human-readable and machine-readable forms. The machine-readable form may include, without limitation, a barcode. The user 100 may sign (or check off) the user identification label 106 and the cover of the test booklet 104 as a means of associating the user's test booklet 104 and the user 100 by storing the retrieved machine-readable form of the user identification information into the user's recording device 102.

The user 100 may then complete a section of the exam by marking a ‘Begin Section’ area on the first page of a section, answering the questions presented within the section in any order, and marking a ‘Section Done’ area on the last page of the section. This process may be repeated for one or more sections of an exam.

At the conclusion of the last section of the exam, the test administrator may instruct each user 100 to mark a pattern region of the user identification label 106 prior to returning the recording device 102. After the test administrator has retrieved a user's recording device 102, the administrator may download the recorded information from the recording device 102 into an information-processing device 108, such as a computer. Alternatively, the test administrator may mark a ‘Test Complete’ pattern region that prepares the information-processing device 108 to receive information from the recording device 102. The recorded information may then be downloaded into a database 110 located on the information-processing device 108. Optionally, the information-processing device 108 may indicate if the transfer was successful or whether an error occurred. The test administrator may resolve any errors prior to completing the download of information from the recording device 102. Once the information has been successfully downloaded into the information-processing device 108, an interpreter 112 may interpret the stored information as responses to the exam. Additionally, physical written responses are recorded on the test booklet 104 which may be used for verification, archival and/or other purposes.

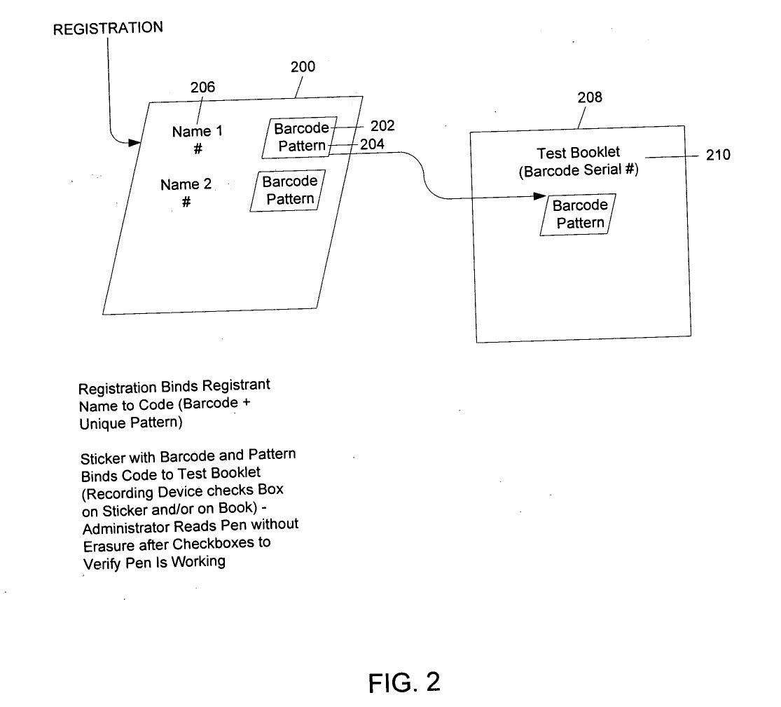

An exemplary method of managing the identity of a user using a recording device is shown in FIG. 2. The particular embodiment depicted in FIG. 2 performs identity management in a test-taking environment, but the invention is not limited to such an embodiment. The method of identifying a user's identity may be performed in an electoral environment, a survey environment or any other environment in which a user selects an option by marking an answer area on a physical document using a recording device.

In FIG. 2, registration is performed by using a recording device to scan an identification label containing a barcode 202 and a unique pattern 204 associated with the name of a particular user 206 on a user name list 200. The unique pattern 204 may include the user's signature, a checkmark or any other symbol or set of symbols. The barcode 202 and unique pattern 204 may be physically detachable from the user name list 200. For example, the barcode 202 and unique pattern 204 may be placed on a sticker that may be removed from the user name list 200 after being scanned by a recording device. The barcode 202 and unique pattern 204 for a particular user may then be placed on the user's test booklet 208. A barcode serial number 210 on the user's test booklet 208 may then be scanned by a recording device to associate it with the recording device.

In an alternate embodiment, a roster sheet may be used to record attendance and other administrative data. The roster sheet may provide identifying information for each examinee instead of providing such information on an identification label. A test administrator may mark an area of the roster sheet associated with an examinee with a recording device provided to the examinee for taking the exam. As such, the examinee is associated with the recording device by the actions of the test administrator. At the conclusion of the exam, the identification information, administrative information and recorded response information may be downloaded from the recording device to an information-processing device.

In an alternate embodiment, the roster sheet may be used in conjunction with the identification labels described above in reference to FIG. 2. In this embodiment, test administrators may mark a roster sheet with their own recording devices as users are given exam materials. This allows attendance data to be recorded in a single recording device so that the data may be downloaded at the conclusion of the administration of the exam.

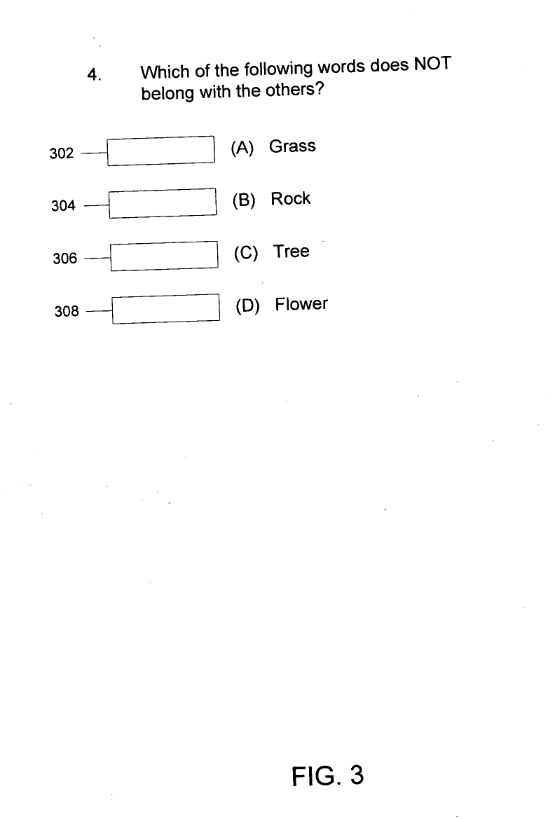

In order to utilize a dual mode writing instrument in a testing or assessment setting, it is imperative that the user of the writing instrument be able to change their selected responses one or more times, yet unambiguously indicate their final selection in both the physical written format and electronically. FIGS. 3-7 are depictions of a sample question in which one or more of the selection, deselection and reselection techniques are performed according to an embodiment of the present invention. Not shown in FIGS. 3-7 is the recording device pattern, which may underlay either the entire area of the sample question or any smaller area containing the answer areas next to each answer choice.

In FIG. 3, examinees may use the answer areas 300, 302, 304, and 306 next to each choice to indicate their selection. In an embodiment, placing a checkmark inside an answer area marks the answer associated with the checked answer area as the examinee's desired selection.

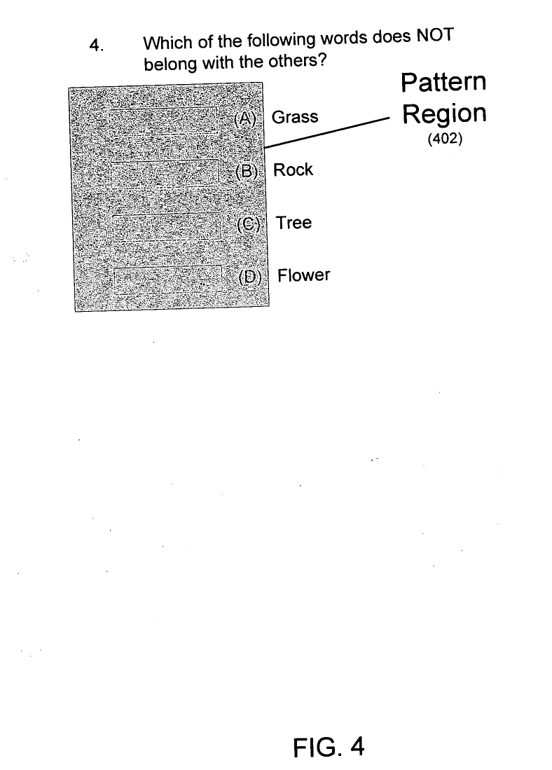

FIG. 4 shows a depiction of an exemplary pattern region in which selection and deselection techniques are practiced according to an embodiment. When an exam booklet is designed, the booklet is divided into questions. Responses to each question are made by placing a checkmark within a corresponding pattern region, such as 402. A pattern region 402 is uniquely formatted to correspond a particular exam question with a mark made within the pattern region 402. This formatting may be performed by laying a specific pattern underneath a pattern region 402. Each pattern region 402 may contain a different pattern. Software may interpret the location of the recording device within the pattern based on the layout of the pattern within the pattern region 402 after recorded data is uploaded from the recording device.

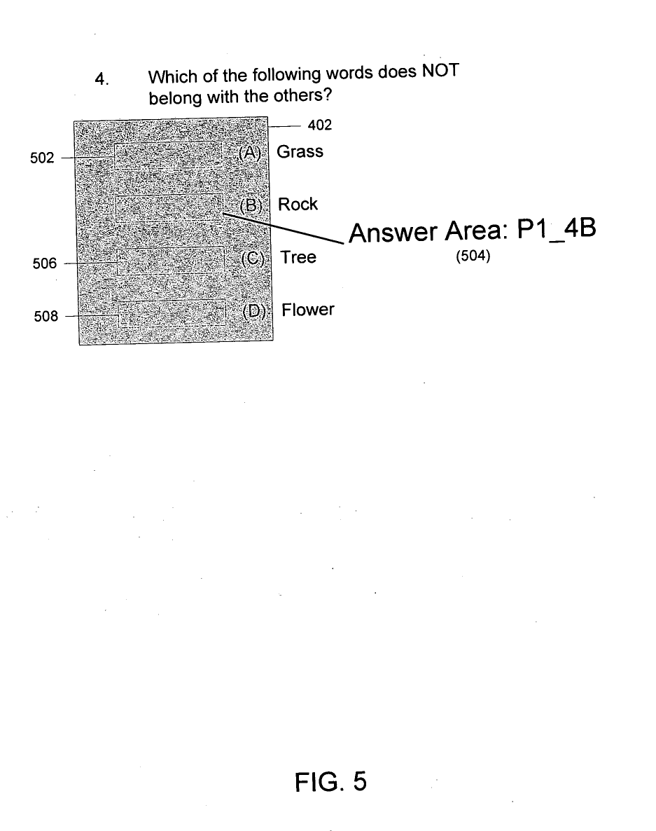

FIG. 5 shows a depiction of an exemplary answer area in which selection, deselection and reselection techniques are practiced according to an embodiment. Within the pattern region 402, one or more answer areas may be defined. In FIG. 5, four answer areas, 502, 504, 506, and 508, are shown, but an embodiment may include any number of answer areas within a given pattern region 402. An answer area, such as 504, may be defined by assigning coordinates to an answer choice, such as B, within a pattern region 402. In doing so, exam response assessment may be performed based on the location and type of response made in a given answer area for a given pattern region 402.

In an embodiment, a pattern region contains only one answer area. Such a pattern region may be used to receive a written response to an essay, short answer or other question. In such a case, the entire pattern region provided for the answer is encoded as an answer area for the given question. In this embodiment, it may not be necessary to know the precise location of marks made by a recording device since the entire set of data within a pattern region will be converted into an image for scoring purposes.

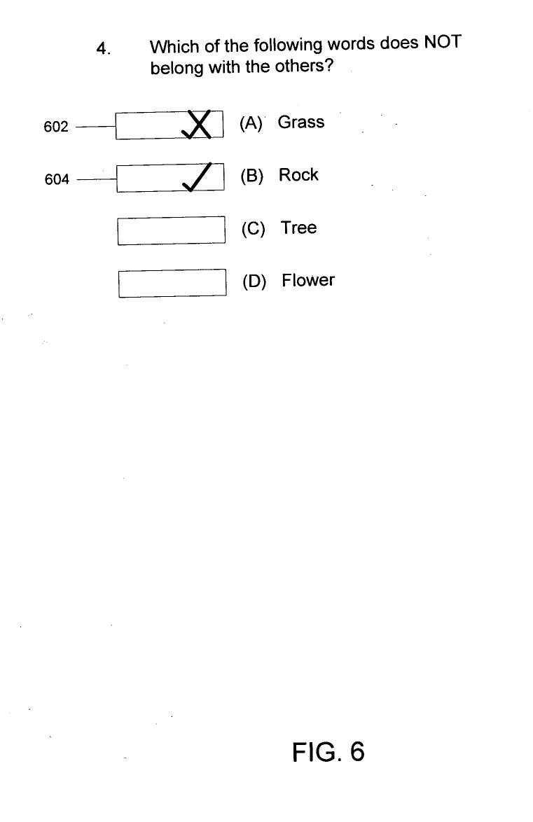

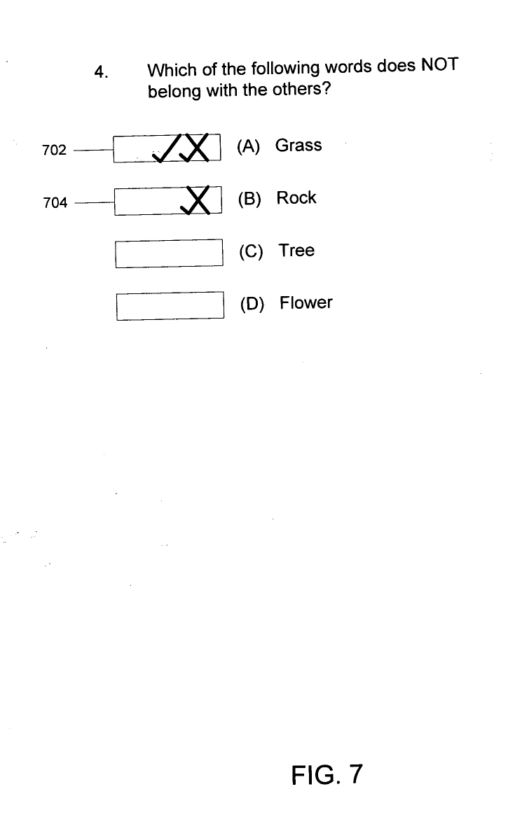

The examinee may change his selection by placing a checkmark in a newly desired answer area 604 and crossing out the checkmark in the undesired answer area 602 as shown in FIG. 6. In an embodiment, the placement of the checkmark in the newly desired answer area and the crossing out of the checkmark in the undesired answer area may be performed in either order. If an examinee wishes to change an answer back to a previously selected answer, the examinee may place a new checkmark in a previously checked answer area 702 and cross out the checkmark in the undesired answer area 704 as shown in FIG. 7. The exemplary answer areas may permit an examinee to change his answer multiple times for a given question. Moreover, the crossed out checkmarks may be detected by using standard geometric algorithms that search for intersecting line segments within the same answer area with substantially different slopes. In alternative embodiments, “crossing out” checkmarks in undesired answer areas may be performed by using at least one horizontal line, at least one vertical line, a combination of horizontal and vertical lines, or any other method that is recognizable by both humans and an information-processing device adapted to receive information from a recording device.

The ideal symbology is one that is both easily constructed and easily understood by an individual in an examination or assessment setting. To be easily constructed, the symbol must be one which most individuals can draw naturally and without much effort and should be no more complicated that a common letter of the alphabet. Easily understood symbols are those which evoke a positive connotation (such as a checkmark) for selecting a response item and a negative connotation (such as an “x”) for deselection of an item. In addition, the symbology should be one that can be quickly discerned between selection and deselection.

One mechanism for constructing effective symbology for use in the present invention is to have the deselection symbol be a derivative of the selection symbol by adding significant additional markings to the selection symbol. The significance of the additional markings may be determined quantitatively. For example, a quantitative analysis may determine the surface covered by a mark. If the surface area is below a given threshold, the mark is determined to be a selection. Conversely, if the surface area is above a given threshold, the mark is determined to be deselection. For example, a slash covers a relatively small area, while as crossing over it with an intersecting line (to turn it into an “x”) covers a relatively larger area. The same is true of use of a vertical line (i.e. “|”) as an indicator for selection. The surface area covered by a vertical line can be increased by a relatively significant amount by intersecting it with a horizontal line turning the symbol into a plus sign (i.e. “+”) for deselection. In both examples, the mark for selection (i.e. the checkmark or vertical line) may be unambiguously distinguished both visually and electronically from the mark for deselection (i.e. the “x” or the plus sign).

Another mechanism for easily discerning between selection and deselection is to have the deselection symbol override the selection symbol such as in the instance of utilizing an open circle for selection and an x overlaying the open circle to indicate deselection. Each of these mechanisms is useful and unambiguously indicates selection and deselection in a written format.

In order to be effectively utilized with a dual mode writing instrument in the present invention, selection versus deselection symbology must also be unambiguous in both a physical visual format and an electronic format. A straightforward way of achieving this is to utilize visually distinct marks that are electronically distinguishable by computational devices implementing geometric algorithms. Electronically, a computer program can discern between no selection (i.e. no response being selected or deselected), selection and deselection by utilizing one or more methodologies.

In addition, since the dual mode writing instrument records all marks made with the instrument in both the physical written format and the electronic format, means should be provided to discern between an inadvertent mark made with the writing instrument and a mark designed to indicate selection or deselection. An embodiment that recognizes marks that are sufficiently long or that cover a sufficient area may enable use of an algorithm to distinguish stray marks (i.e., those which are not sufficiently long or do not surpass an area threshold) from affirmative marks of selection or deselection (i.e., those which are sufficiently long or surpass an area threshold). The preselected length or area thresholds may be optimally selected to meet the needs of a particular examination or assessment format. For example, referring to FIG. 5, a length threshold may be set to a particular percentage of the height and/or width of an answer area 504. Similarly, an area threshold may be selected as a percentage of the total area of an answer area 504. Those of ordinary skill in the art will recognize that the pre-selected length or area threshold for a selection/deselection symbol may be any percentage of the length or area of an answer area or otherwise relate to a parameter or area of any space utilized as an answer area.

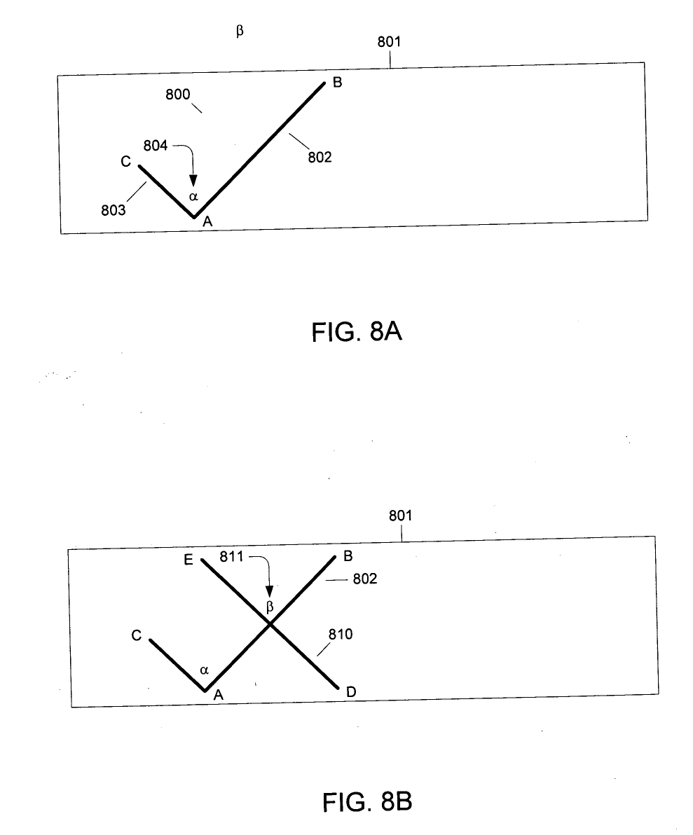

The present methodology similarly uses symbology to support the unambiguous identification of deselection marks. This may permit the use of geometric algorithms to identify marks that should be investigated for deselection. In an embodiment, the algorithms include means to compare two marks to determine the area of overlap or angle of intersection. Optimal symbology may include overlapping symbols (such as a circle for selection and an “x” over the circle for deselection), intersecting symbols or other symbology that can be geometrically distinguished. For example, FIG. 8 depicts the use of a checkmark for selection and an “x” for deselection as utilized in an embodiment. FIG. 8A depicts the use of a checkmark to indicate selection of a response item within the response area 801. As shown, the checkmark 800 is constructed by two co-terminus line segments AB 802 and AC 803 forming the included angle identified as α804. The use of a checkmark for selection of one of a number of response items may satisfy the requirements discussed above. Namely, the checkmark is easily constructed and identified by an individual in written format as an affirmative response. In addition, in electronic format as utilized herein, the line segment AB 802 should be of a length exceeding a preselected threshold. In the electronic format, the line segment AC 803 may essentially be disregarded as insignificant to electronically interpreting the checkmark 800 as an indicator of selection. Accordingly, line segment AC 803 can be of minimal length and α804 can be zero. FIG. 8B depicts the use of line segment DE 810 to indicate deselection of the response item selected in FIG. 8A. In the physical written format, the intersection of line segment DE 810 and line segment AB 802 is easily constructed and is understood to have the negative connotation associated with deselection. In electronic format, line segment DE 810 should be of sufficient length to be significant either pursuant to the parameters set forth above or in relation to the line segment AB 802. In addition, line segment DE 810 and line segment AB 802 create an angle of intersection β811. β811 must be of sufficient magnitude to be discemable as an indication of negative intent. In an embodiment, β may range from approximately 15° to approximately 165°. Other ranges for β may be used within the scope of this invention. Marks falling within these parameters are classified as deselected versus selected with high accuracy by analyzing the significance of the line segments and their angles of intersection.

Although the invention has been described with reference to the preferred embodiments, it will be apparent to one skilled in the art that variations and modifications are contemplated within the spirit and scope of the invention. The drawings and description of the preferred embodiments are made by way of example rather than to limit the scope of the invention, and it is intended to cover within the spirit and scope of the invention all such changes and modifications.

What is claimed is:

1. A method for receiving at least one response using a recording device and a recording medium, the method comprising:
associating a recording device and a recording medium with a user;
recording at least one electronic response for each of a plurality of items using the recording device;
contemporaneously recording at least one written response on the recording medium, wherein each written response corresponds to an electronic response; and
storing the at least one electronic response in a computer-readable storage medium.

2. The method of claim 1, further comprising:
determining a value for each stored electronic response.

3. The method of claim 2, further comprising:
reporting at least one value.

4. The method of claim 2, further comprising:
reporting whether the value corresponds to an assigned value for the item to which the value pertains.

5. The method of claim 2, further comprising:
generating one or more statistics based on at least one value.

6. The method of claim 1 wherein storing the at least one electronic response comprises:
storing the at least one electronic response in the computer-readable storage medium in a record pertaining to the user.

7. The method of claim 1 wherein assigning a recording device and a recording medium with a user comprises:
storing a user identification using the recording device;
scanning a user identification label associated with the recording medium using the recording device; and
electronically storing a representation of the user identification label in the recording device.

8. The method of claim 7 wherein storing a user identification comprises signing, by the user, the user's name.

9. The method of claim 7 wherein storing a user identification comprises physically marking the user identification label.

10. The method of claim 7 wherein storing a user identification comprises physically marking the recording medium.

11. The method of claim 7 wherein scanning the user identification label comprises scanning a barcode on the user identification label.

12. The method of claim 1, further comprising:
verifying an electronic response using a corresponding written response.

13. A method for managing the identity of a user using a recording device, the method comprising:
scanning, using a recording device, user information from an identification label associated with a user;
storing the user information in a computer-readable storage medium associated with the recording device;
placing the identification label on a recording medium;
scanning, using the recording device, recording medium information from the recording medium; and
storing the recording medium information in the computer-readable storage medium.

14. The method of claim 13 wherein the recording medium information comprises a barcode value for the recording medium.

15. The method of claim 13 wherein storing the recording medium information comprises storing the recording medium information in a record pertaining to the user.

16. The method of claim 13 wherein the user information comprises one or more of the following:
a barcode value associated with the user;
a unique pattern associated with the user; and
a signature for the user.

17. A method for selecting a response for an item using a recording device on a recording medium, the method comprising:
marking a first response area of a plurality of response areas pertaining to an item on a recording medium, wherein marking the first response area corresponds to a first response to the item; and
contemporaneously storing a first electronic representation of the first response in a computer-readable storage medium, wherein the first electronic representation comprises one or more of a shape for the first response, an encompassed area within the first response area for the first response, and a location for the first response within the recording medium.

18. The method of claim 17, further comprising:
determining whether the first response is a valid response based on the shape of the first response.

19. The method of claim 17, further comprising:
determining whether the first response is a valid response based on the encompassed area within the first response area for the first response.

20. The method of claim 17, further comprising:
determining whether the first response is a valid response based on the location of the first response.

21. The method of claim 17, further comprising:
deselecting the first response area of the plurality of response areas on the recording medium, wherein deselecting the first response area comprises making a mark evidencing the deselection of the first response area;
contemporaneously storing a second electronic representation of the mark in the computer-readable storage medium, wherein the second electronic representation comprises one or more of a shape for the mark, an encompassed area within the first response area for the mark, and a location for the mark within the recording medium;
marking a second response area of the plurality of response areas pertaining to an item on the recording medium, wherein marking the second response area corresponds to a second response to the item; and
contemporaneously storing a third electronic representation of the second response in a computer-readable storage medium, wherein the third electronic representation comprises one or more of a shape for the second response, an encompassed area within the second response area for the second response, and a location for the second response within the recording medium.

22. The method of claim 21 wherein the second response area corresponds to a previously selected response area.

23. The method of claim 21 wherein marking the first response area comprises marking the first response area with a checkmark having a short line segment and an elongated line segment.

24. The method of claim 23 wherein deselecting the first response area comprises marking the first response area with a line to form an “x” with the elongated line segment of the checkmark.

25. The method of claim 21 wherein marking the first response area comprises marking the first response area with a circle.

26. The method of claim 25 wherein marking the first response area comprises marking the first response area with an “X” within the circle.

27. The method of claim 21, further comprising:
determining whether the second response is a valid response based on the shape of the second response.

28. The method of claim 21, further comprising:
determining whether the second response is a valid response based on the encompassed area within the second response area for the second response.

29. The method of claim 21, further comprising:
determining whether the second response is a valid response based on the location of the second response.

30. The method of claim 21, further comprising:
determining whether the mark is a valid deselection based on the shape of the mark.

31. The method of claim 21, further comprising:
determining whether the mark is a valid deselection based on the encompassed area within the first response area for the mark.

32. The method of claim 21, further comprising:
determining whether the mark is a valid deselection based on the location of the mark.

33. The method of claim 32 wherein determining whether the mark is a valid deselection comprises determining whether the mark intersects an elongated line segment of the first response.

34. The method of claim 33 wherein determining whether mark intersects further comprises determining whether an angle at the intersection of the mark and the elongated line segment of the first response is between approximately 15 degrees and approximately 165 degrees.

35. A system for receiving at least one response using a recording device and a recording medium, the system comprising:
a recording device;
a recording medium for receiving written output from the recording device; and
a computer-readable storage medium coupled with the recording device,
wherein the computer-readable storage medium contains one or more programming instruction for implementing a method for receiving at least one response using the recording device and the recording medium, the method comprising:
associating the recording device and the recording medium with a user,
recording at least one electronic response for each of a plurality of items using the recording device,
contemporaneously recording at least one written response on the recording medium, wherein each written response corresponds to an electronic response, and
storing the at least one electronic response in a computer-readable storage medium.

36. The system of claim 35, wherein the computer-readable storage medium further comprises one or more programming instructions for determining a value for each stored electronic response.

37. The system of claim 36, wherein the computer-readable storage medium further comprises one or more programming instructions for reporting at least one value.

38. The system of claim 36, wherein the computer-readable storage medium further comprises one or more programming instructions for reporting whether the value corresponds to an assigned value for the item to which the value pertains.

39. The system of claim 36, wherein the computer-readable storage medium further comprises one or more programming instructions for generating one or more statistics based on at least one value.

40. The system of claim 35 wherein storing the at least one electronic response comprises storing the at least one electronic response in the computer-readable storage medium in a record pertaining to the user.

41. The system of claim 35 wherein assigning a recording device and a recording medium with a user comprises:
storing a user identification using the recording device;
scanning a user identification label associated with the recording medium using the recording device; and
electronically storing a representation of the user identification label in the recording device.

42. The system of claim 41 wherein scanning the user identification label comprises scanning a barcode on the user identification label.

43. The system of claim 35, wherein the computer-readable medium further comprises verifying an electronic response using a corresponding written response.

44. A system for managing the identity of a user using a recording device, the system comprising:
a recording device;
a recording medium for receiving written output from the recording device; and
a computer-readable storage medium coupled with the recording device,
wherein the computer-readable storage medium contains one or more programming instruction for implementing a method for receiving at least one response using the recording device and the recording medium, the method comprising:
scanning, using the recording device, user information from an identification label associated with a user,
storing the user information in a computer-readable storage medium associated with the recording device,
placing the identification label on a recording medium,
scanning, using the recording device, recording medium information from the recording medium, and
storing the recording medium information in the computer-readable storage medium.

45. The system of claim 44 wherein the recording medium information comprises a barcode value for the recording medium.

46. The system of claim 44 wherein storing the recording medium information comprises storing the recording medium information in a record pertaining to the user.

47. The system of claim 44 wherein the user information comprises one or more of the following:
a barcode value associated with the user;
a unique pattern associated with the user; and
a signature for the user.

48. A system for selecting a response for an item using a recording device on a recording medium, the system comprising:
a recording device;
a recording medium for receiving written output from the recording device; and
a computer-readable storage medium coupled with the recording device,
wherein the computer-readable storage medium contains one or more programming instruction for implementing a method for receiving at least one response using the recording device and the recording medium, the method comprising:
marking, using the recording device, a first response area of a plurality of response areas pertaining to an item on a recording medium, wherein marking the first response area corresponds to a first response to the item, and
contemporaneously storing a first electronic representation of the first response in a computer-readable storage medium, wherein the first electronic representation comprises one or more of a shape for the first response, an encompassed area within the first response area for the first response, and a location for the first response within the recording medium.

49. The system of claim 48 wherein the computer-readable storage medium further comprises one or more programming instructions for determining whether the first response is a valid response based on the shape of the first response.

50. The system of claim 48 wherein the computer-readable storage medium further comprises one or more programming instructions for determining whether the first response is a valid response based on the encompassed area within the first response area for the first response.

51. The system of claim 48 wherein the computer-readable storage medium further comprises one or more programming instructions for determining whether the first response is a valid response based on the location of the first response.

52. The system of claim 48 wherein the computer-readable storage medium further comprises one or more programming instructions for:
deselecting the first response area of the plurality of response areas on the recording medium, wherein deselecting the first response area comprises making a mark evidencing the deselection of the first response area;
contemporaneously storing a second electronic representation of the mark in the computer-readable storage medium, wherein the second electronic representation comprises one or more of a shape for the mark, an encompassed area within the first response area for the mark, and a location for the mark within the recording medium;
marking a second response area of the plurality of response areas pertaining to an item on the recording medium, wherein marking the second response area corresponds to a second response to the item; and
contemporaneously storing a third electronic representation of the second response in a computer-readable storage medium, wherein the third electronic representation comprises one or more of a shape for the second response, an encompassed area within the second response area for the second response, and a location for the second response within the recording medium.

53. The system of claim 52 wherein the second response area corresponds to a previously selected response area.

54. The system of claim 52 wherein marking the first response area comprises marking the first response area with a checkmark having a short line segment and an elongated line segment.

55. The system of claim 54 wherein deselecting the first response area comprises marking the first response area with a line to form an “X” with the elongated line segment of the checkmark.

56. The system of claim 52 wherein marking the first response area comprises marking the first response area with a circle.

57. The system of claim 56 wherein marking the first response area comprises marking the first response area with an “X” within the circle.

58. The system of claim 52 wherein the computer-readable storage medium further comprises one or more programming instructions for determining whether the second response is a valid response based on the shape of the second response.

59. The system of claim 52 wherein the computer-readable storage medium further comprises one or more programming instructions for determining whether the second response is a valid response based on the encompassed area within the second response area for the second response.

60. The system of claim 52 wherein the computer-readable storage medium further comprises one or more programming instructions for determining whether the second response is a valid response based on the location of the second response.

61. The system of claim 52 wherein the computer-readable storage medium further comprises one or more programming instructions for determining whether the mark is a valid deselection based on the shape of the mark.

62. The system of claim 52 wherein the computer-readable storage medium further comprises one or more programming instructions for determining whether the mark is a valid deselection based on the encompassed area within the first response area for the mark.

63. The system of claim 52 wherein the computer-readable storage medium further comprises one or more programming instructions for determining whether the mark is a valid deselection based on the location of the mark.

64. The system of claim 63 wherein determining whether the mark is a valid deselection comprises determining whether the mark intersects an elongated line segment of the first response.

65. The system of claim 64 wherein determining whether mark intersects further comprises determining whether an angle at the intersection of the mark and the elongated line segment of the first response is between approximately 15 degrees and approximately 165 degrees.

66. A method for indicating selection using a recording device on a recording medium, the method comprising:
marking an area pertaining to a selectable item on a recording medium with a mark, wherein marking the area corresponds to selecting the item; and
contemporaneously storing an electronic representation of the selection in a computer-readable storage medium, wherein the electronic representation comprises one or more of a shape for the mark, an encompassed area for the mark within the area pertaining to the selected item, and a location for the mark within the recording medium.

67. The method of claim 66, further comprising:
deselecting the item on the recording medium, wherein deselecting the item comprises making a second mark evidencing the deselection of the item; and
contemporaneously storing a second electronic representation of the second mark in the computer-readable storage medium, wherein the second electronic representation comprises one or more of a shape for the second mark, an encompassed area within the first response area for the second mark, and a location for the second mark within the recording medium.

68. A system for indicating selection using a recording device on a recording medium, the method comprising:
a recording device;
a recording medium for receiving written output from the recording device; and
a computer-readable storage medium coupled with the recording device,
wherein the computer-readable storage medium contains one or more programming instruction for implementing a method for indicating selection using the recording device on the recording medium, the method comprising:
marking, using the recording device, an area pertaining to a selectable item on the recording medium with a mark, wherein marking the area corresponds to selecting the item, and
contemporaneously storing an electronic representation of the mark in the computer-readable storage medium, wherein the electronic representation comprises one or more of a shape for the mark, an encompassed area for the mark within the area pertaining to the selected item, and a location for the mark within the recording medium.

69. The system of claim 68, wherein the computer-readable storage medium further contains one or more programming instructions for:
deselecting the item on the recording medium, wherein deselecting the item comprises making a second mark evidencing the deselection of the item; and
contemporaneously storing a second electronic representation of the second mark in the computer-readable storage medium, wherein the second electronic representation comprises one or more of a shape for the second mark, an encompassed area within the first response area for the second mark, and a location for the second mark within the recording medium.
